(19) United States
(12) Patent Application Publication
(10) Pub. No.: US 2014/0283928 A1
(43) Pub. Date: Sep. 25, 2014

(54) FLOW AMOUNT CONTROL APPARATUS

(71) Applicant: NITTO SHOJI, LTD., Osaka (JP)

(72) Inventors: Yasuyuki TAMATE, Osaka (JP); Shigeru HAYAMA, Osaka (JP)

(73) Assignee: NITTO SHOJI, LTD., Osaka (JP)

(21) Appl. No.: 14/025,202

(22) Filed: Sep. 12, 2013

(30) Foreign Application Priority Data
Mar. 25, 2013 (JP) 2013-062956

(51) Int. Cl. G05D 7/06

(52) U.S. Cl. CPC G05D 7/0694
USPC 137/389

(57) ABSTRACT

A flow amount control apparatus is configured to include a supply tank for storing a liquid, a main pipe having a first open end connected to the tank and a second open end disposed lower than the first end for transferring the liquid from the tank to the second end, a supply valve capable of preventing the liquid from flowing into the main pipe, the supply valve being placed between the tank and the second end, a branch pipe having a third open end connected to the main pipe at a position between the supply valve and the second end and a fourth open end disposed above the third end, a flow amount adjustment means for controlling an amount of the flowing liquid, a liquid level detection unit for detecting a liquid level in the branch pipe, a timer, and a controller for controlling the flow amount adjustment means.

The present disclosure relates to subject matter contained in Japanese Patent Application Nos. 2012-069623 and 2013-062956 filed on Mar. 26, 2012 and Mar. 25, 2013, respectively, the contents of which are herein expressly incorporated by reference in its entirety.

### BACKGROUND OF THE INVENTION

1. Field of the Invention

The present invention relates to an apparatus for supplying micro-amounts of liquid continuously and stably.

2. Description of the Related Art

Widely demanded is continuous and stable supplying of micro-amounts of liquid in various fields such as medical practices, machining operations, and fuel cells. Positive displacement pumps (variable discharge pressure pumps) such as a diaphragm pump, a plunger pump, and an electromagnetic pump is well known as a means for transferring liquid (solution sending).

Positive displacement pumps transfer (flow) the liquid in a chamber by repeatedly changing the cavity confined between a suction valve and a discharge valve. It is the pressure due to repeated change of cavity to transfer the liquid accommodated in the cavity, and essentially causes a pressure pulsation of the transferred liquid. The pressure pulsation disables stable transfer of a very little amount of liquid at a flow rate of 1 cc/minutes or less.

In FIG. 9, shown is a pumpless liquid dispensing system disclosed in European Patent Laid-Open Publication No. EP0971165A2 (hereinafter Patent Document 1). The same system dispenses micro-amounts of lubricating liquid in a sealable liquid reservoir 130 through a dispensing nozzle 120. It is not a pump but the difference between the pressures in the reservoir 130 and the nozzle 120 that makes the liquid flow. Specifically, a pressurized air fed in an air supply line 103 is regulated to a second pressure by a second pressure regulator 150, and then supplied to a common liquid air turn-off valve 180. The pressurized air is further regulated to a first pressure (approximately 5 psi) by a first pressure regulator 140, and then supplied to the reservoir 130. Note that the first pressure is lower than the second pressure.

The reservoir 130 stores the liquid therein in a water tight manner, and will presses out the liquid therefrom toward a liquid supply line 104 when the air of first pressure is supplied thereto. The liquid goes through the common liquid air turn-off valve 180 and a liquid flow control vale 160, and then will be discharged from an inner liquid dispensing opening 124 via a liquid inlet 122 of the nozzle 120.

The air of second pressure goes through the common liquid air turn-off valve 180 and an air flow control valve 170, then will be supplied to the nozzle 120, and further will be discharged from an outer pressurized air dispensing opening 128 around the opening 124, reducing an air pressure around the opening 124 to an air pressure lower than the atmospheric pressure. The differential pressure between the first pressure (higher than the atmospheric pressure) in the reservoir 130 and the pressure (lower than the atmospheric pressure) around the opening 124 pushes the liquid or fluid in the reservoir 130 by a uniform pressure thereout.

Flexible hoses are used for both the liquid supply line 104 and the air supply line 103. The liquid flow control valve 160 and the air flow control valve 170 both have a structure for clamping two plates by screw, wherein the flow amounts of the liquid and the air of second pressure are adjusted by deforming the flexible hoses.

As described in the above, the air flow control valve 170 is used to control channel cross section of the air supply line 103 for the control of the flow amount of the air of second pressure. The liquid flow control valve 160 is used to control channel cross section of the liquid supply line 104 for the control of the flow amount of the liquid. Thus, the amount of the liquid discharged from the dispensing nozzle 120 is adjusted by adjusting the flow amounts of the air of second pressure and the liquid.

In the Patent document 1, the liquid stored in the sealable liquid reservoir 130 is pushed out by the air to flow through the liquid supply line 104 and the liquid flow control valve 160, and then enters the dispensing nozzle 120. The amount of the liquid discharged from the dispensing nozzle 120 is adjusted by the operation of the air flow control valve 170 and the liquid flow control valve 160. Specifically, the liquid is discharged from the sealable liquid reservoir 130 in the below described procedure.

The cross-sectional shape of the air supply line 103 is deformed by operating the air flow control valve 170, making flow amount of the air entering the dispensing nozzle 120 change. This change of air flow amount makes the pressure (negative) in the nozzle 120 change, making the differential pressure between the first pressure in the sealable liquid reservoir 130 and the pressure (negative) in the inner liquid dispensing opening 124 change. According to the difference between the first pressure in the reservoir 130 and the pressure in the opening 124, caused by the change in pressure in the nozzle 120, the force (differential pressure) pushing the liquid in the reservoir 130 out is adjusted.

The amount of liquid entering the liquid inlet 122 of the dispensing nozzle 120 is adjusted as follows. The liquid flow control valve 160 is operated to deform the cross-sectional shape of the liquid supply line 104, making the channel cross section of liquid discharged from the sealable liquid reservoir 130 change. According to the change of liquid flow amount by changing the channel cross section, the amount of liquid flowing into the inlet 122 from the line 104 is adjusted.

Apparently, it is inevitable to structure both the air supply line 103 and the liquid supply line 104 with the flexible hose. It is very difficult to make a fine adjustment of the flow amount of fluid such as gas or liquid by clamping the flexible hose to deform thereof. Therefore, the system disclosed in the Patent Document 1 is inherently inferior to control precisely the flow of very small amount of fluid.

Furthermore, it is very difficult to maintain the very small flow amount continuously. Even if the total amount of the fluid flown for a long time (for example, longer than ten minutes) is some grams or some cc, the flowing rate per time possibly changes radically. In this case, it can not be recognized that the very little flow amount of fluid is controlled stably and continuously. In other words, the method in the Patent Document 1 can not dynamically control the flow amount which will change as the time passes, making very difficult to supply a very little amount of liquid stably and continuously.

### SUMMARY OF THE INVENTION

In light of the problems encountered by the conventional techniques, it is an object of the present invention to provide a flow amount control apparatus which can supply a very little amount of liquid stably and continuously.

In order to achieve the above object, a flow amount control apparatus according to the present invention comprises:

a supply tank for storing a liquid;

a main pipe having a first open end connected to the supply tank in a water tight manner and a second open end disposed at a position lower than the first open end with respect to the gravity for transferring the liquid from the supply tank to the second open end;

a supply valve capable of preventing the liquid from flowing into the main pipe, the supply valve being placed at a position between the supply tank and the second open end;

a branch pipe having
a third open end connected to the main pipe in a water tight manner at a position between the supply valve and the second open end and
a fourth open end disposed at a position above the third open end with respect to the gravity;

a flow amount adjustment means for controlling an amount of the liquid flowing between the third open end and the second open end in response to a control signal, the means being connected to at least one of the second open end and the fourth open end;

a liquid level detection unit for detecting a liquid level in the branch pipe at two positions;

a timer; and

a controller for controlling the flow amount adjustment means in response to a first signal sent from the timer and a second and third signals sent from the liquid level detection unit.

In the present invention, the liquid in the supply tank can be supplied by a very little amount continuously. Since the amount being supplied can be determined based on the change of the liquid level in the branch pipe, the flow amount can be controlled by measuring the flowing liquid by a very little amount every several seconds.

The above and other objects and features of the present invention will become apparent from the following description of preferred embodiments given in conjunction with the accompanying drawings.

### BRIEF DESCRIPTION OF THE DRAWINGS

FIG. 1 is a diagram schematically showing a construction of a flow amount control apparatus according to a first embodiment of the present invention;

FIG. 2 is a diagram schematically showing a construction of an atomizer unit in FIG. 1;

FIG. 3 is a flow chart showing an operation executed by the flow amount control apparatus in FIG. 1;

FIG. 4 is an enlarged view of a liquid level detection unit in FIG. 1;

FIG. 5 is a diagram schematically showing a construction of a flow amount control apparatus according to an alternative of the first embodiment of the present invention;

FIG. 6 is a diagram schematically showing a construction of a flow amount control apparatus according to a second embodiment of the present invention;

FIG. 7 is a diagram schematically showing a construction of a flow amount control apparatus according to a third embodiment of the present invention;

FIG. 8 is a flow chart showing an operation executed by the flow amount control apparatus in FIG. 7; and

FIG. 9 is a diagram schematically showing a conventional pumpless liquid dispensing system.

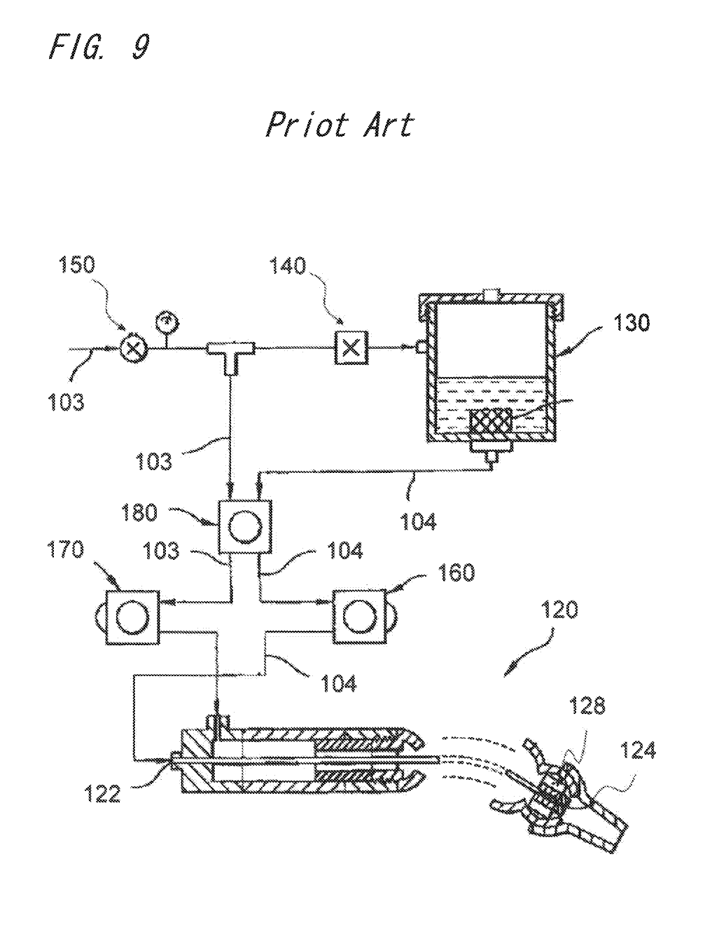

### DETAILED DESCRIPTION OF THE PREFERRED EMBODIMENTS

With reference to the drawings, some embodiment of the present invention will be described below. The flow amount control apparatus is embodied as apparatuses which atomize a very little amount of liquid and spray thereof continuously. More specifically, the flow amount control apparatuses able to spray a little amount of liquid, such as some cc per minute, stably and continuously are described as examples.

### First Embodiment

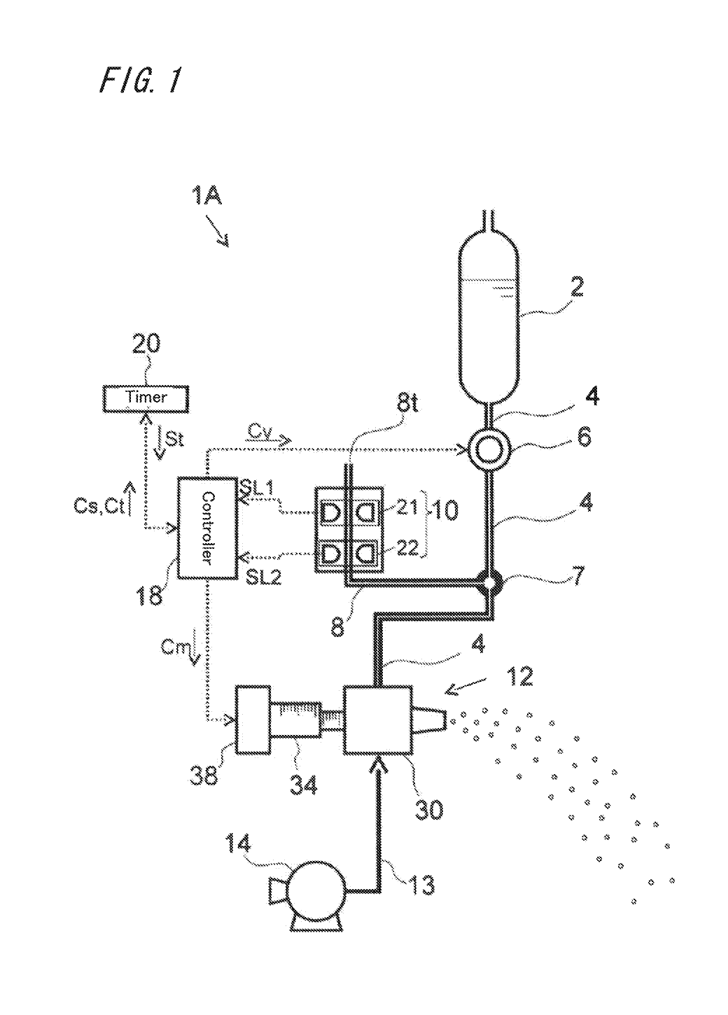

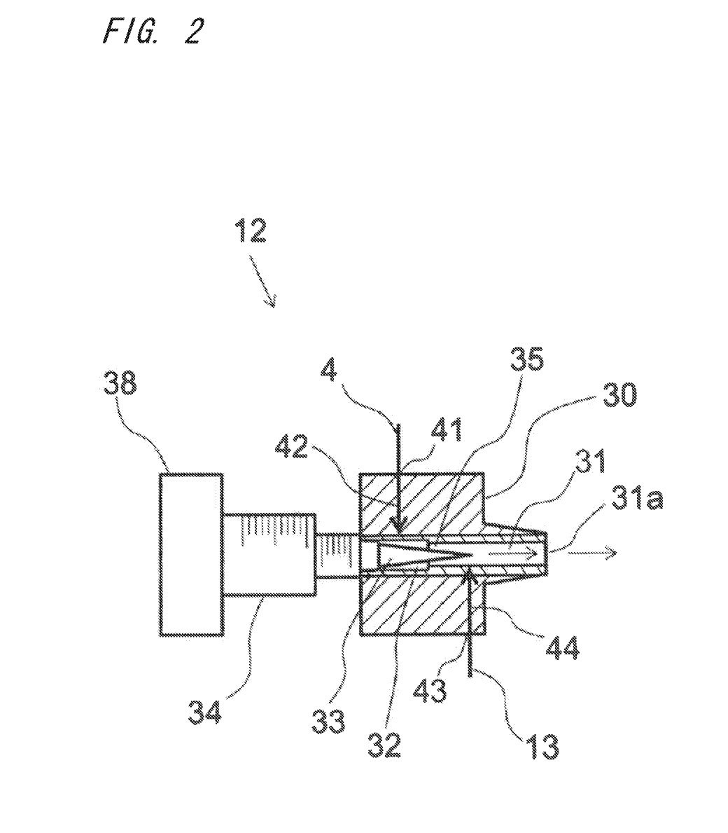

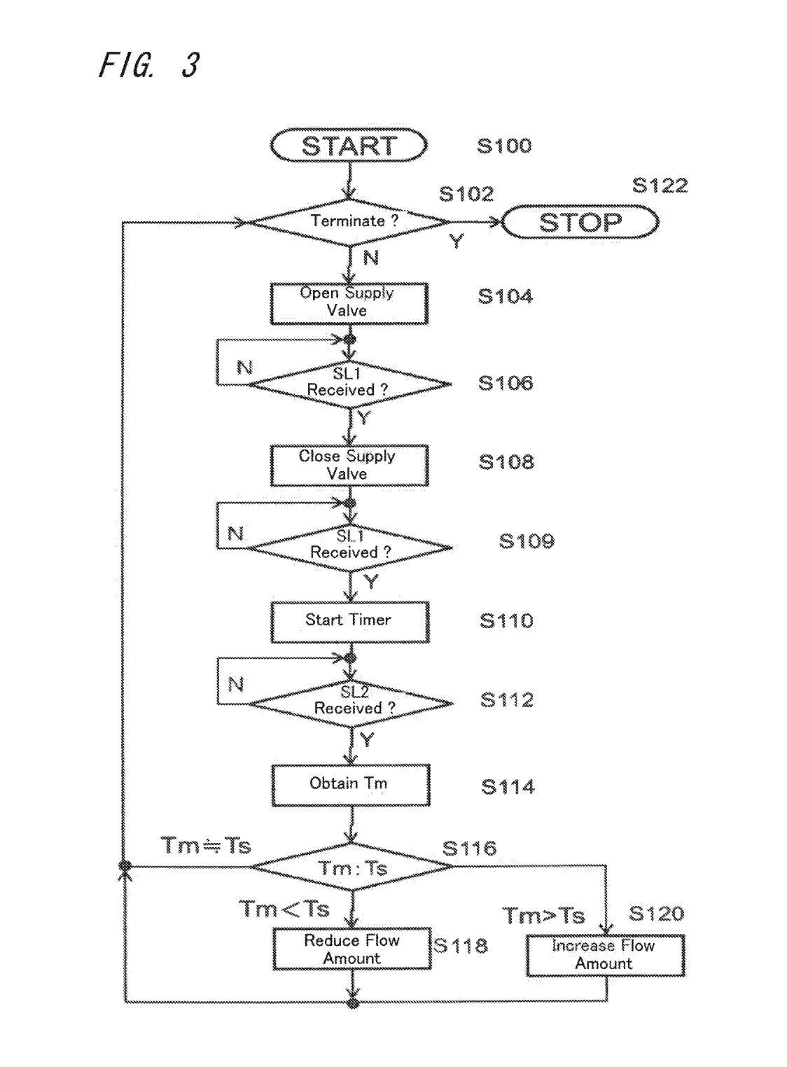

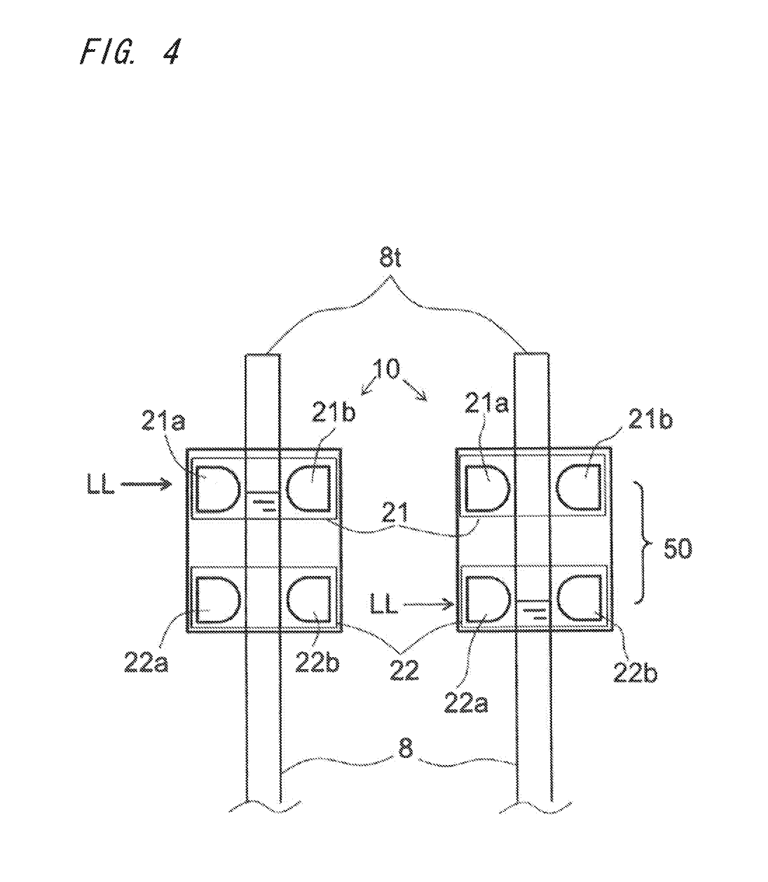

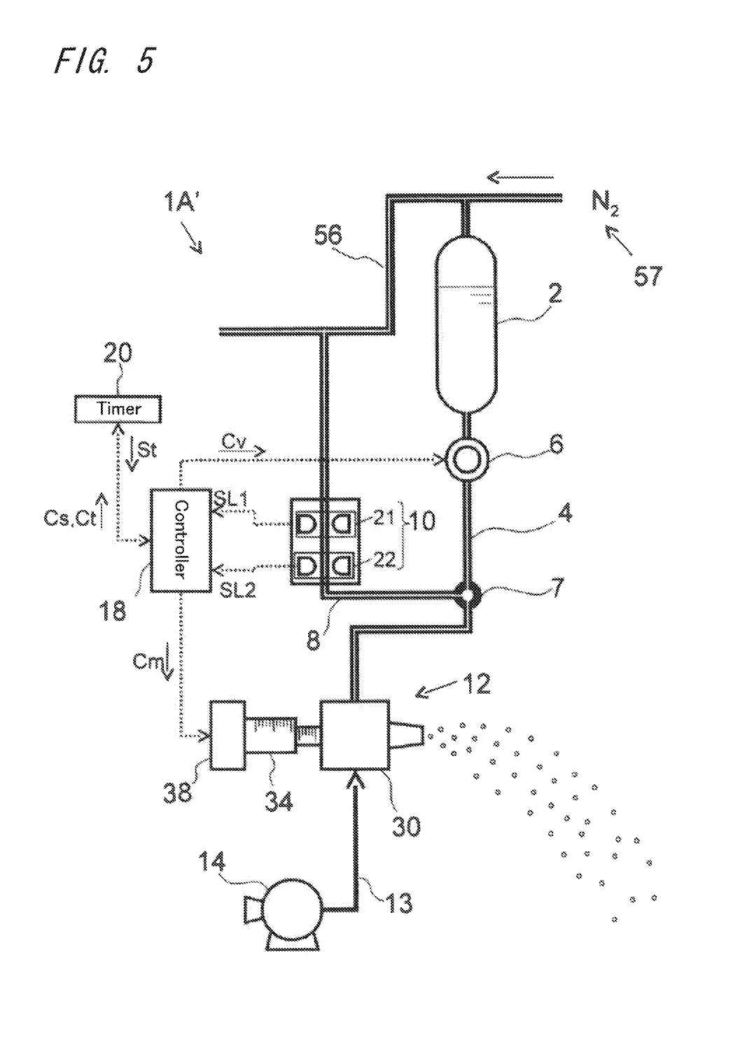

With reference to FIG. 1, FIG. 2, FIG. 3, FIG. 4, and FIG. 5, a flow amount control apparatus according to a first embodiment of the present invention will be described below.

In FIG. 1, shown is the construction of a flow amount control apparatus 1A according to the present embodiment. The flow amount control apparatus 1A includes a supply tank 2, a main pipe 4, a supply valve 6, a branch pipe 8, an atomizer unit 12, a liquid level detection unit 10, a timer 20, and a controller 18.

In the flow amount control apparatus 1A, the supply tank 2, the supply valve 6, the branch pipe 8, and the atomizer unit 12 are arranged in this order from the upper to lower position with respect to the gravity. The supply tank 2, opened to the atmospheric air, stores the liquid to be flow amount controlled. The stored liquid is subjected to the atmospheric pressure. The supply tank 2, the supply valve 6, the branch pipe 8, and the atomizer unit 12 are mutually connected (communicate) via the main pipe 4 in a water tight manner.

Only demanded for the main pipe 4 is to transfer the liquid stored in the supply tank 2 to the atomizer unit 12. As long as this demand is satisfied, any shape or any connection manner to the supply tank 2 other than those shown in the embodiment is acceptable.

For example, the main pipe 4 can be connected to the lowest portion of the supply tank 2. The main pipe 4 can be extended from an upper portion of the supply tank 2 toward the bottom of the supply tank 2 downwardly with respect to the gravity as the supply tank 2 is shut tightly at the bottom. The main pile 4 can be irregular in the thickness or diameter. According to the present invention, as will be described later, the volume of the fluid discharged from a pressure nozzle 30 of the atomizer unit 12 is detected based on the changes of liquid level in the branch pipe 8.

The supply valve 6 can be placed at any position between the main pipe 4 and the supply tank 2. The supply valve 6 can be provided on any side of the main pipe 4 and the supply tank 2. Only demanded for the supply valve 6 is to be controlled by the controller 18 so that the flow of the liquid from the supply tank 2 to the main pipe 4 can be controlled. As long as this demand is satisfied, any construction other than shown in the embodiment is acceptable.

One end of the branch pipe 8 is connected to the main pipe 4 via a communication portion 7 provided below the supply valve 6 with respect to the gravity. The other end 8t of the branch pipe 8 is opened to the atmosphere at a position above the communication portion 7 with respect to the gravity. The liquid level detection unit 10 is provided in an open end portion of the branch pipe 8 at a position lower than the supply valve 6 with respect to the gravity. Thus arranged liquid level detection unit 10 detects the level of the liquid, supplied (flown in) from the supply tank 2, in the branch pipe 8.

As previously described, the main pipe 4 communicates with the atomizer unit 12. By a pneumatic pipe 13, the atomizer unit 12 is connected to a pump 14 which supplies a compressed air. The atomizer unit 12 is constructed to be able to control the discharging amount of the liquid. In other words, the atomizer unit 12 constructs a flow amount adjustment means for adjusting or controlling the amount of the liquid flowing between the communication portion 7 and an open end of the main pipe 4 on the side of atomizer unit 12, as will be specifically described later.

In FIG. 2, specifically shown is a construction of the atomizer unit 12. The pressure nozzle 30 has a cylindrical body and a circular truncated conical top (hereinafter, “conical top”) having a common axis. A cylindrical shaped through hole is formed extending along the common axis from the outer end of the conical top to about a middle of the cylindrical body.

A liquid inlet 41 and a compressed air inlet 43 are formed on the circumferential surface of the cylindrical body at the positions far from and near the conical top, respectively. The liquid inlet 41 and the compressed air inlet 43 communicate with the main pipe 4 and the pneumatic pipe 13, respectively.

Inside the pressure nozzle 30, a barrel 31 defined by a constant diameter is provided along the common axis. The barrel 31 extends from the outer end of the nozzle 30 (right side in FIG. 2) to about a middle of the cylindrical body. The barrel 31 is integrated with the through hole.

A liquid path 42 is formed to communicate with the liquid inlet 41 and a chamber 32 inside the cylindrical body. An air path 44 is formed to communicate with the compressed air inlet 43 and the barrel 31 inside the cylindrical body. The compressed air blows into the barrel 31 inside the pressure nozzle 30, and then blows out from an outlet 31a formed at the tip of the conical top.

From the end of the chamber 32, inserted into the barrel 31 is a needle 33 formed in a cone shape with a thick circular base and smooth curved side ending in a point at the top thereof such that the smooth curved side, and the top locate near the outlets of liquid path 42 and air path 44, respectively. Inside the barrel 31, a gap is formed between the curved surface of the needle 33 and the inner circumferential surface of the barrel 31. Through this gap, the liquid coming from the liquid path 42 goes toward the tip of the conical top (open end 31a of the pressure nozzle 30). This gap is referred to as a liquid passing portion 35. A size (cross-sectional area) of this gap (the liquid passing portion 35) can be adjusted by moving the needle 33 along the common axis.

The needle 33 is arranged in the chamber 32 to which the liquid enters from the main pipe 4 via the liquid inlet 41. The needle 33 can be moved forward (to the tip of the conical top) and backward (to the end of the cylindrical body) along the common axis as the root thereof been kept water tight. The root of the needle 33 is fixed to spindle top of a micrometer 34 whose thimble is held by a stepper motor 38.

By bi-directional movement of the needle 33, a cross-sectional area of the liquid passing portion 35 can be adjusted. When the (atmospheric) pressure applied to the liquid stored in the supply tank 2 is constant, the flow amount per time of the liquid passing through the liquid passing portion 35 can be adjusted by moving the needle 33.

In the atomizer unit 12, the liquid entering from the liquid inlet 41 stays in the chamber 32. The compressed air entering from the compressed air inlet 43 blows out from the outlet 31a, causing the pressure in the barrel 31 (hereinafter, “barrel pressure”) to be negative. Since the supply tank 2 is opened to the atmospheric pressure, the barrel pressure is lower than the atmospheric pressure by a certain pressure which is a differential pressure. The liquid in the main pipe 4 is pressed by the differential pressure and the gravity to flow into the chamber 32. The liquid passes through the liquid passing portion 35, and is then blown out together with the compressed from the outlet 31a.

According to the first embodiment, the flow amount of liquid is adjusted by the adjustment of the cross-sectional area of the liquid passing portion 35 inside the pressure nozzle 30. More specifically, the amount of liquid blown out is determined by the size of the gap between the circumferential surface of needle 33 and the inner circumferential surface of barrel 31 (the liquid passing portion 35). The size of the gap is determined by the movement of needle 33 along the common axis. The movement of needle 33 is adjusted by the operation of the micrometer 34. That is, the amount of liquid blown out can be adjusted by the operation of the micrometer 34 to move the spindle.

As described with reference to FIG. 1, the liquid level detection unit 10 is provided around the open end portion of the branch pipe 8 in a position lower than the supply valve 6 with respect to the gravity. The liquid level detection unit 10 includes a first and a second sensors placed two positions apart from each over by a predetermined distance in a gravity direction for detecting a change of liquid level in the branch pipe 8. The first sensor 21 in the upper position and the second sensor 22 in the lower position will output signals SL1 and SL2 on the detection of liquid level, respectively. For liquid level detection unit 10, an optical sensing means are preferably adopted, but not limited thereto. In this embodiment, the first and second sensors 21 and 22 are optical sensors.

Furthermore, a combination of light-emitting diode (LED) and phototransistor is inexpensive with a high precision. Those detection signals (SL1, SL2) are sent to the controller 18. The branch pipe 8 is preferably made of a transparent material so that the liquid level detection unit 10 detects the level of liquid in the branch pipe 8 by emitting light on the branch pipe 8 from the outside.

The controller 18 is a computer including a memory and a Micro Processor Unit (MPU). The controller 18 is connected to the supply valve 6 and the stepper motor 38 for controlling their operations. More specifically, the supply valve 6 turns ON or OFF based on a command Cv sent from the controller 18. Based on a command Cm sent from the controller 18, the stepper motor 38 rotates by a predetermined angle to operate (turn) the thimble of the micrometer 34.

The controller 18 receives the signals SL1 and SL2 sent from the liquid level detection unit 10. The controller 18 is connected to the timer 20. The timer 20 starts to measure time on receipt of a command Cs sent from the controller 18, and stops the time measuring on receipt of a command Ct sent from the controller 18. The controller 18 obtains the measured time based on a signal St sent from the timer 20. The timer 20 can be integrated in the controller 18.

With reference to FIG. 3, the operation of the flow amount control apparatus 1A will be described below. Initially, in the atomizer unit (flow amount adjustment means) 12 (see FIG. 2), the position of needle 33 and cross-sectional area of the liquid passing portion 35 are adjusted so that a predetermined amount of the liquid will be discharged. Initial positioning of the needle 33 may be made manually before starting the operation of the apparatus 1A or made when the apparatus 1A is turned on in step S100. A predetermined amount of compressed air is supplied to the barrel 31 at a predetermined pressure.

Since the end potion 8t of the branch pipe 8 is opened, the liquid in the branch pipe 8 is subjected to the atmospheric pressure. Then, the predetermined amount of the liquid will be blown out from the outlet 31a of the atomizer unit 12.

The controller 18 is set a set time Ts by a suitable means (not shown in the drawings). The set time Ts is a standard flowing time necessary for a predetermined amount of liquid to flow in a flow speed while the very little amount of the liquid can be supplied stably and continuously. “Supplying the very little amount of liquid stably and continuously” is what the present invention aims at.

According to this embodiment, the set time Ts is a standard time needed for a predetermined amount of liquid moves from an upper level which the first sensor 21 detect to a lower level which the second sensor 22 detect. As described in detail later, this predetermined amounts whose moving time is measured by the first and second sensors 21 and 22 is defined as a control volume 50, and an actual period used for the control volume 50 moves from the upper level to the lower level is defined as a passed time Tm. The amount of liquid discharged from the pressure nozzle 30 is controlled by adjusting the openings (gap size) of needle 33 so that the passed time Tm becomes equal to the set time Ts.

In step S100, the operation of the flow amount control apparatus 1A is initialized and started by being turned on. Then, the procedure advances to step S102.

In step S102, it is judged whether the operation shall be terminated or not. When it is judged as “Yes”, the procedure advances to step S122 wherein the operation of the apparatus 1A is stopped (Step S122). When it is judged as “No”, the procedure advances to step S104.

In step S104, the supply valve 6 is opened, allowing the liquid in the supply tank 2 to flow into the main pipe 4 toward the atomizer unit 12. Then the procedure advances to a next step S106.

In step S106, it is repeatedly judged whether the controller 18 received the signal SL1 or not, till it is judged as “Yes”. Then the procedure advances to the next step S108.

Before describing about the step S108, the liquid state after the step S104 before the step S108 is described. The amount of liquid flowing in the main pipe 4 is greater than the amount of liquid discharged from the atomizer unit 12. Therefore, the liquid will be stored by the amount that is not discharged.

The level of stored (not discharged) liquid goes upwardly from the atomizer unit 12 with respect to the gravity as time goes by. In short time, the backward flow of stored liquid enters the branch pipe 8 through the communication portion 7 and goes up inside the branch pipe 8.

The liquid level detection unit 10 is arranged beside the vertical portion of the branch pipe 8 to monitor the levels of the backward flowing liquid, and sends signals SL1 and SL2 when the liquid levels are detected by the sensors 21 and 22, respectively.

Therefore, judging “Yes” in the step S106 means that the level of stored liquid reaches the upper position which the first sensor 21 detect through the lower position which the second sensor 22 detect.

In step S108, the controller 18 sends the command Cv to the supply valve 6 in response (S106) to the signal SL1 from the liquid level detection unit 10. The supply valve 6 is closed. Note that the liquid flow into the main pipe 4 will continue with reducing the flow rate till the valve 6 becomes closed completely. Therefore, the liquid level goes up beyond the upper position which the first sensor 21 detects and stops.

Then, before or after the supply valve 6 is completely closed, when the amount of liquid flowing into the main pipe 4 from the supply tank 2 becomes less than the amount of liquid discharged from the atomizer unit 12 or zero, in the branch pipe 8 the liquid level over the upper position begins to go down.

In step S109, it is judged whether the controller 18 received the signal SL1 or not, till it is judged as “Yes”. The procedure advances to a next step S110.

In step S110, the controller 18 sends the command Cs to the timer 20 in response to the signal SL1 (step S109). The timer 20 starts to measure the time passed after the liquid levels reaches the upper position again. Then, the procedure advances to a next step S112.

In step S112, it is judged whether the controller 18 received the signal SL2 or not, till it is judged as “Yes”. The procedure advances to a next step S114.

In FIG. 4, the liquid level detection unit 10 is shown in an enlarged scale. In the left half of FIG. 4, shown is the unit 10 when the liquid level LL is on the upper position which the first sensor 21 detects and sends the signal SL1. The first sensor 21 is constructed with a LED 21b and a phototransistor 21a.

In the right half of FIG. 4, shown is the unit 10 when the liquid level LL is on the lower position which the second sensor 22 detects and sends the signal SL2. The second sensor 22 is constructed with an LED 22b and a phototransistor 22a. The volume of the liquid confined by the upper and lower positions is the control volume 50. The flow amount control apparatus 1A controls the flow amount so that the control volume 50 of the liquid is blown out in the set time Ts.

Therefore, the branch pipe 8 preferably has a constant inner diameter at least of the portion where the liquid level detection unit 10 is arranged for the precise measurement of control volume 50.

Referring back to FIG. 3, the operation after the above described step S112 will be described.

In step S114, the controller 18 sends the command Ct to the timer 20 in response to the signal SL2 (step S112) meaning that the liquid level LL reached the lower level again. The timer 20 stops time measuring and sends the signal St to the controller 18. The controller 18 obtains the passed time Tm based on the signal St.

As described in the above, the passed time Tm is an actual period used for the control volume 50 to move from the upper level to the lower level. The control volume 50 divided by the passed time Tm gives a flow amount per a unit time (a volume per a unit time). In this sense, it is possible to say that the passed time Tm is equivalent to an actual flow amount of the control volume 50.

Thus, according to the present invention, the passed time Tm can be measured with an extreme precision, resulting in an extremely precise measurement of the actual flow amount of control volume 50.

In a next step S116, the controller 18 compares the passed time Tm obtained in step S114 with the set time Ts predetermined in the system.

When the passed time Tm is greater than the set time Ts, it is judged that the amount of liquid being discharged is less than required amount. The procedure advances to a step S120.

In step S120, the controller 18 sends the Command Cm to the stepper motor 38 to move the needle 33 backward by a predetermined distance to increase the cross-sectional area of the liquid passing portion 35. Then, the procedure returns step S102.

When the passed time Tm is smaller than the set time Ts in step S116, it is judged that the amount of liquid being discharged is more than required amount. The procedure advances to step S118.

In step S118, the controller 18 sends the Command Cm to the stepper motor 38 to move the needle 33 forward by a predetermined distance to reduce the cross-sectional area of the liquid passing portion 35. Then, the procedure returns step S102.

When the passed time Tm and the set time Ts are substantially the same in step S116, the procedure returns to the step S102 without making any operation.

After returning step S102, the above described operations in step S102 to S120 will be repeated till it is judged as “Yes” in step S102.

While the operations in S102 to S120 are repeatedly executed, the flow amount can be controlled so that the time used to blow out the liquid (passed time Tm) becomes equal to the set time Ts. That is, the flow amount can be controlled so that the control volume of liquid stored in the branch pipe 8 between the upper position (the first sensor 21) and the lower position (the second sensor 22) will be blown out in the set time. Thus, the precise measurement of the control volume 50 enables to flow a predetermined amount of liquid stably and continuously for a predetermined period.

Furthermore, the flow amount is controlled based on the level change of the liquid in the branch pipe 8. Therefore, a very little flow amount can be measured and controlled every several seconds precisely as the branch pipe 8 or the main pipe 4 are formed with fine diameters.

For example, it is possible make a flow amount adjustment by controlling the atomization unit 12 to discharge some cc of liquid every several seconds/minutes. Consequently, even with the atomization unit 12 not so good in precision, a stable and continuous supply of liquid can be secured.

Next, with reference to FIG. 5, an alternative of the first embodiment according to the present invention is described. This alternative aims to supply a very little amount of fluid without exposing the fluid to an air or moisture. Specifically, purged with an inert gas are a space in the branch pipe 8 confined from between the stored liquid level and the end portion 8t (typically shown in FIG. 1) as well as a space inside the supply tank 2.

As more specifically shown in FIG. 5, a flow amount control apparatus 1A′ is constructed by adding an inert gas source 57 and an inert gas pipe 56 to the flow amount control apparatus 1A (FIG. 1). An inert gas in use is a nitrogen gas. The inert gas pipe 56 is extended from the inert gas source 57, and is connected to the supply tank 2 and the end portion 8t in an air tight manner.

The nitrogen gas is flown into the inert gas pipe 56 to purge the air and/or the moisture therefrom with a fluid pressure enough to move the nitrogen gas slightly. Excessive fluid pressure affects the fluid supply by the apparatus 1A′. The inert gas source 57 and the inert gas pipe 56 construct an inert gas purge means. The flow amount control apparatus 1A′ can handle a liquid such as solvent to be free from oxidization or hydration.

### Second Embodiment

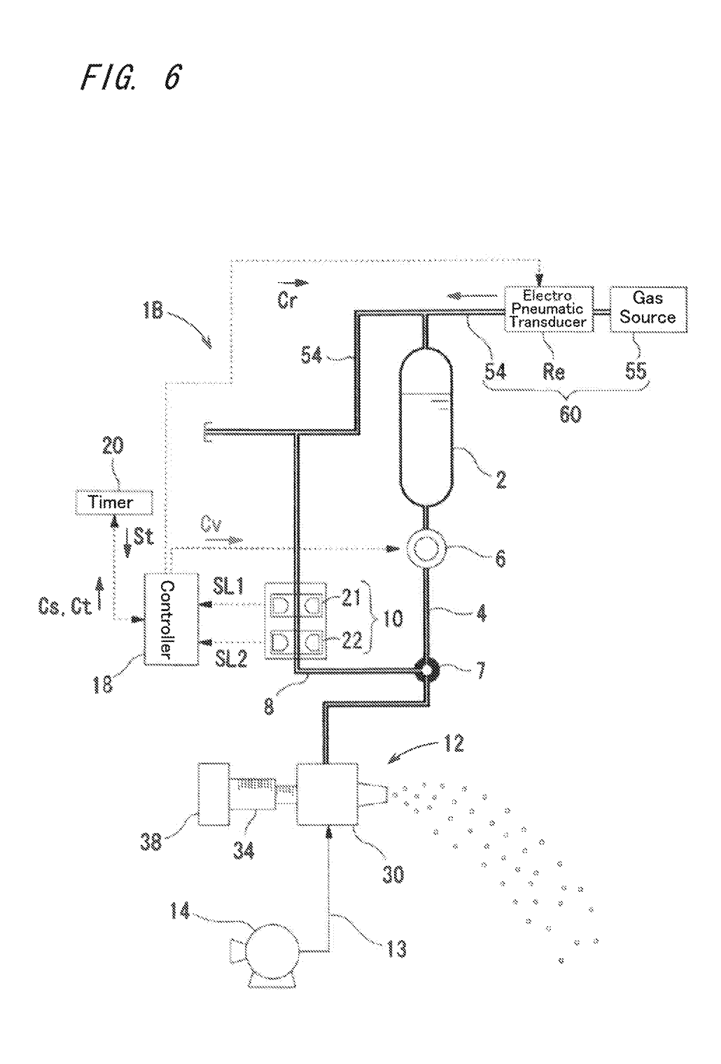

With reference to FIG. 6, a flow amount control apparatus according to a second embodiment of the present invention is described. A flow amount control apparatus 1B is constructed by replacing the inert gas source 57 and the inert gas pipe 56 in the apparatus 1A′ (FIG. 5) with a gas source 55 and a gas pipe 54, respectively, and by adding an electro pneumatic transducer Re.

The gas source 55 is constructed, unlike the inert gas source 57, to be able to supply any gas having a pressure Ps higher than the atmospheric pressure including inert gases (gaseous body). The pressure Ps is predetermined arbitrarily according to the apparatus 1B. The gas pipe 54 is constructed to be able to flow the gas supplied by the gas source 55 in an air tight manner. The gas pipe 54 is closed at one end on the side of branch pipe 8 (the end portion 8t, typically shown in FIG. 1) and is connected to the gas source 55 via the electro pneumatic transducer Re in an air tight manner at the other end.

The gas source 55 supplies a fourth open end and the supply tank 2 with the gas (preferably, an inert gas such as a nitrogen gas) having a pressure Pr lower than the pressure Ps and higher than the atmospheric pressure via the electro pneumatic transducer Re. That is, in the flow amount control apparatus 1B, unlike the above described apparatuses 1A and 1A′, the liquid stored in the branch pipe 8 and the supply tank 2 is applied with the gas pressure greater than the atmospheric pressure. Note that the electro pneumatic transducer Re adjusts the pressure Ps of the gas (preferably, nitrogen gas), supplied in the gas pipe 54 from the gas source 55, to the predetermined pressure Pr in response to a control signal Cr output from the controller 18. Thus, the gas pressure Pr acting on the liquid stored both in the branch pipe 8 and the supply tank 2 can be adjusted to a target pressure Prc. The gas source 55, the gas pipe 54, and the electro pneumatic transducer Re construct a gas pressure adjustment means 60 for adjusting the pressure of gas being supplied in the supply tank 2 and the branch pipe 8.

In the flow amount control apparatus 1B, the flow amount of liquid is controlled by a manner different from the manners in the flow amount control apparatuses 1A (FIG. 1) and 1A′ (FIG. 5) according to the first embodiment. Specifically, in the first embodiment (apparatuses 1A and 1A′), the flow amount of liquid is adjusted by controlling a position of the needle 33 for adjusting the gap (the liquid passing portion 35).

On the contrary, in the second embodiment (apparatus 1B), the flow amount of liquid is adjusted by adjusting the difference of pressures between in the branch pipe 8 and in the barrel 31 (FIG. 2). More specifically, the adjustment of the differential pressure is made by adjusting the pressure applied to the liquid stored in branch pipe 8. That is, the gas pressure adjustment means 60 functions as a flow amount adjustment means. Before starting operation by the apparatus 1B, the needle 33 is set in a position giving a predetermined gap (liquid passing portion 35) size, which will be described later.

With reference to FIG. 3, an operation particular to the apparatus 1B, compared with the apparatus 1A (FIG. 1), will be described below.

In step S100, the flow amount control apparatus 1B is additionally initialized with respect to the gas pressure Pr and the position of needle 33, not executed for the apparatuses 1A or 1A′. Specifically, to make the gas pressure Ps become the initial pressure Pr, the electro pneumatic transducer Re is set. The initial pressure Pr is selected from a range from about 1.05 atm to 1.2 atm, and preferably is about 1.1 atm. It is needless to say that the initial positioning of the needle 33 can be made manually before the step S100. The operations in steps S104 to S116 are the same as those in the apparatus 1A or 1A′.

In steps S118 and S120, it is the same that the controller 18 makes an control for reducing and increasing the discharging mount of liquid in steps S118 and S120, respectively, as in the apparatuses 1A or 1A′. However, actions taken are different from those in the first embodiment.

Specifically, according to this embodiment, the controller 18 sends the command Cr to the electro pneumatic transducer Re to increase the gas pressure Pr by a predetermined amount in step S120. Also, the controller 18 sends the command Cr to the electro pneumatic transducer Re to reduce the gas pressure Pr by a predetermined amount in step S118.

As described in the above, according to this embodiment, the fourth open end is connected to the gas source 55 via the electro pneumatic transducer Re in an air tight manner. Thanks to this, the liquid flowing inside the main pipe 4 toward the pressure nozzle 30 is free from the affection by a fluctuation of the atmospheric pressure. The pressure acting on the fourth open end is adjusted according to the fluctuation of liquid flow amount, enabling a stable and continuous supply of a very little amount of liquid.

### Third Embodiment

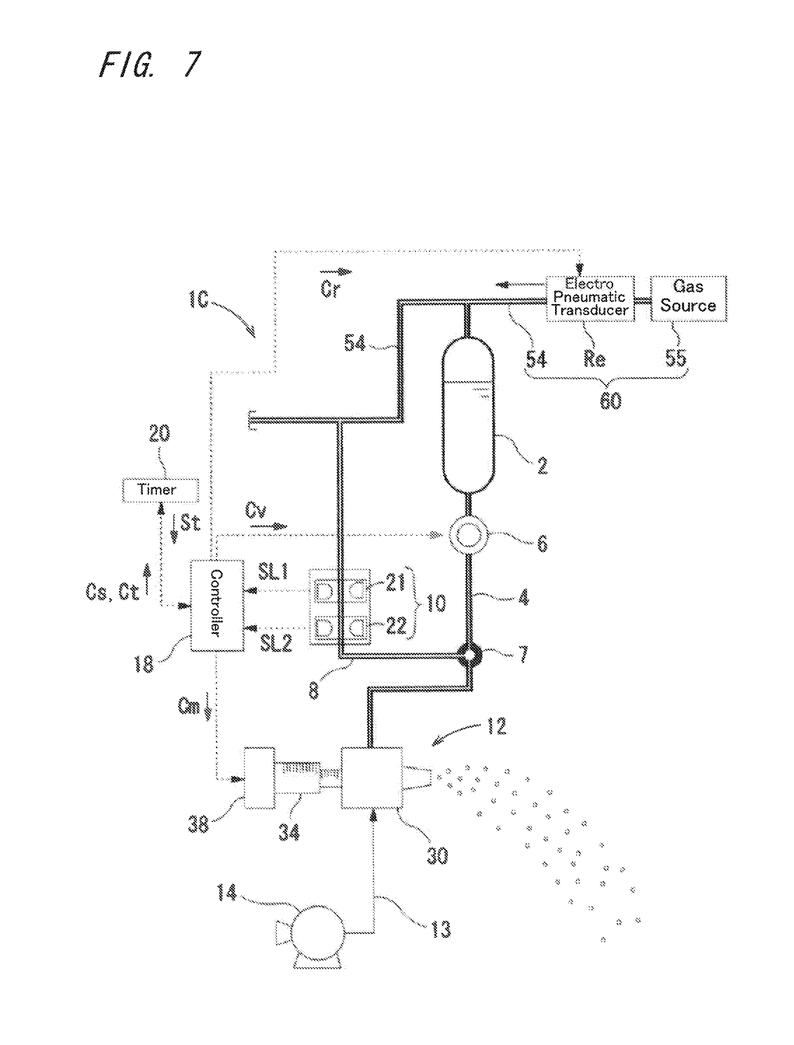

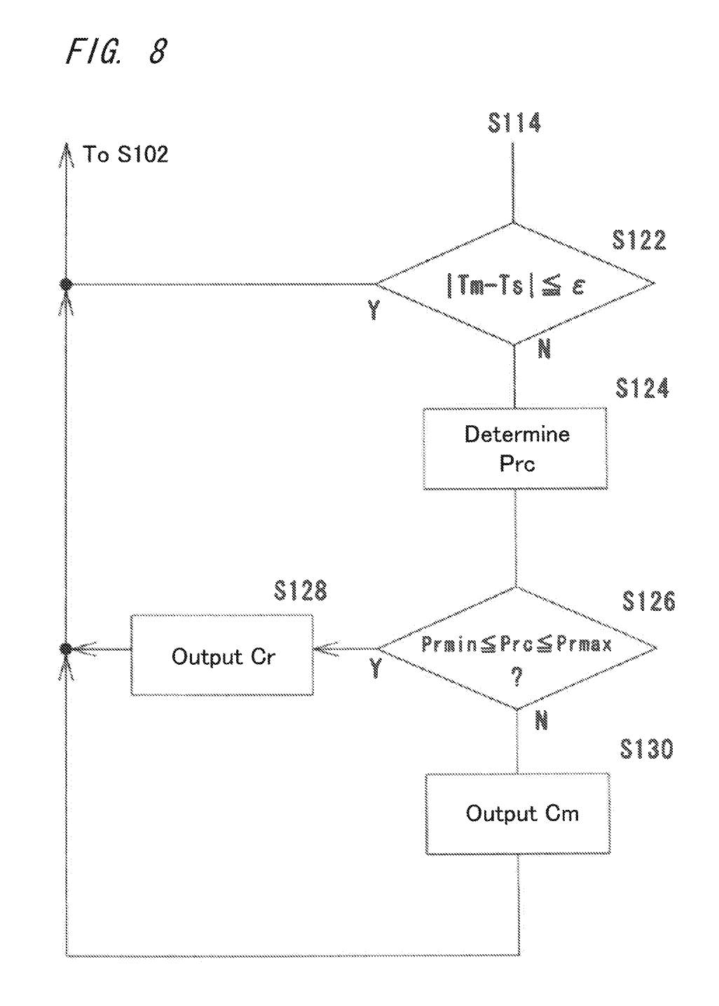

With reference to FIGS. 7 and 8, a flow amount control apparatus according to a third embodiment of the present invention is described. In simple term, the flow amount control apparatus 1C is constructed by combining the apparatus 1A (FIG. 1) and the apparatus 1B (FIG. 6).

In the flow amount control apparatus 1C, adjustments are made in a coordinated fashion both for the needle's position inside the pressure nozzle 30 (barrel 31) in the apparatus 1A and for the gas pressure inside the supply tank 2 in the apparatus 1B. The control signal Cr and the command Cm are output independently based on the signals SL1 and SL2 from the liquid level detection unit 10. The atomization unit 12 and the gas pressure adjustment means 60 construct a flow amount adjustment means.

With reference to FIG. 8, the operation of the flow amount control apparatus 1C will be described mainly with respect to the signals SL1 and SL2 from the liquid level detection unit 10. In FIG. 8, steps S116, S118, and S120 in FIG. 3 are replaced with steps S122, S124, S126, S128, and S130. In FIG. 8, only steps S122 to S130 particular to this embodiment are indicated for the sake of brevity.

In step S122, the passed time Tm obtained through the steps S102 to S114 is compared with the set time Ts. Specifically, it is judged whether an absolute value of the difference between the passed time Tm and the set time Ts is equal to or smaller than a predetermined value ε, or not. “ε” is a maximum fluctuation of the passed time Tm, when the liquid flow amount is within the expected and allowable range in this embodiment.

In this sense, “ε” is referred to as “an allowable fluctuation time ε”. The allowable fluctuation time ε is an evaluation criteria for judging whether the flow amount of liquid actually discharged can be allowed as the target flow amount determined by the flow amount control apparatus 10, or not. When the absolute value of the difference between the passed time Tm and the set time Ts is equal to or smaller than the allowable fluctuation time ε, no adjustment of flow amount is required.

Therefore, in a case that it is judged as “No” in step S122, the control still fails to realize the target flow amount. Then, the procedure advances to step S124.

In Step S124, determined is the target gas pressure Prc making the passed time Tm equal to the set time Ts. The gas pressure Prc is the target value of the gas pressure Pr after being adjusted by the electro pneumatic transducer Re.

The target gas pressure Prc is determined so that the difference between the passed time Tm and the set time Ts becomes smaller than the allowable fluctuation time ε, and more preferably becomes zero. The target gas pressure Prc is experimentally determined and is stored in a suitable format such as a table incorporated in the controller 18. Then, the procedure advances to next step S126.

In step S126, it is judged whether the target gas pressure Prc is within in an allowable pressure range (Prmin to Prmax) which the electro pneumatic transducer Re can adjust, or not. When the target gas pressure Prc is within the allowable pressure range, it is judged as “Yes”. Then, the procedure advances to step S128.

In step S128, the controller 18 outputs the control signal Cr to make the electro pneumatic transducer Re adjust the gas pressure Pr inside the fourth open end to the target gas pressure Prc. The procedure returns to step S102.

When it is judged as “No”, the target gas pressure Prc is beyond the allowable pressure range. Then, the procedure advances to step S130.

In step S130, the operations in the steps S118 and S120 are combined so that the command Cm is output to the stepper motor 38 to increase or reduce the gap (the liquid passing portion 35) size. Then, the procedure returns to step S102.

In this embodiment, in a case that the flow amount fluctuation is within the pressure range adjustable by the electro pneumatic transducer Re, the flow amount is adjusted by the electro pneumatic transducer Re as in the second embodiment. In a case that the flow amount fluctuation is beyond the pressure range adjustable by the electro pneumatic transducer Re, the flow amount is adjusted by moving the needle 33 on the predetermined position as in the first embodiment.

In this embodiment, to lessen the difference between the passed time Tm and the set time Ts, either one of the flowing force adjustment by adjusting the gas pressure and a adjustment of a cross-sectional size of the liquid passing portion by adjusting a gap thereat is selected. Resultantly, the flow amount of liquid can be adjusted more rapidly.

The flow amount control apparatus according to the present invention can be used in various fields such as medical practices, machining operations, and fuel cells.

While preferred embodiments of the invention have been described using specific terms, such description is for illustrative purposes only, and it is to be understood that changes and variations may be made without departing from the spirit or scope of the following claims.

What is claimed is:

1. A flow amount control apparatus comprising:
a supply tank for storing a liquid;
a main pipe having a first open end connected to the supply tank in a water tight manner and a second open end disposed at a position lower than the first open end with respect to the gravity for transferring the liquid from the supply tank to the second open end;
a supply valve capable of preventing the liquid from flowing into the main pipe, the supply valve being placed at a position between the supply tank and the second open end;
a branch pipe having
a third open end connected to the main pipe in a water tight manner at a position between the supply valve and the second open end and
a fourth open end disposed at a position above the third open end with respect to the gravity;
a flow amount adjustment means for controlling an amount of the liquid flowing between the third open end and the second open end in response to a control signal, the means being connected to at least one of the second open end and the fourth open end;
a liquid level detection unit for detecting a liquid level in the branch pipe at two positions;
a timer; and
a controller for controlling the flow amount adjustment means in response to a first signal sent from the timer and a second and third signals sent from the liquid level detection unit.

2. The flow amount control apparatus according to claim 1, wherein the flow amount adjustment means includes:
a pressure nozzle having a barrel, a chamber, and an outlet, the barrel and chamber being provided in a through hole formed therein;
a needle arranged in the chamber and movable forward and backward with respect to the outlet, the needle having a root fixed to a micrometer having a thimble;
an air path for blowing an air into the barrel;
a liquid path communicating with the chamber and the second open end; and
a stepper motor for holding the thimble of the micrometer.

3. The flow amount control apparatus according to claim 1, wherein the flow amount adjustment means includes:
a gas source capable of supplying a gas having a first predetermined pressure higher than an atmospheric pressure;
a gas pipe connecting the gas source to the fourth open end in an air tight manner; and
an electro pneumatic transducer provided between the gas source and the gas pipe for adjusting the pressure of the supplied gas to a second predetermined pressure lower than the first predetermined pressure and higher than the atmospheric pressure to supply the pressure adjusted gas to the gas pipe.

4. The flow amount control apparatus according to claim 3, wherein the gas is an inert gas.

5. The flow amount control apparatus according to claim 1, wherein the liquid level detection unit includes an optical sensor for detecting the liquid level in the branch pipe by emitting light on the branch pipe from outside thereof.

6. The flow amount control apparatus according to claim 1, further comprising an inert gas purge means for purging the supply tank and the fourth open end with an inert gas.
